(19) United States
(12) Patent Application Publication
(10) Pub. No.: US 2020/0340298 A1
(43) Pub. Date: Oct. 29, 2020

(54) LAMELLA BLIND SYSTEM

(71) Applicant: Ramboll Denmark Contracting ApS, Copenhagen S (DK)

(72) Inventors: Jakob Blauenfeldt-Dydensborg, Dragor (DK); Ivar Lauritzen, København S (DK); Jørn Krab Jensen, København K (DK)

(21) Appl. No.: 16/753,679

(22) PCT Filed: Oct. 2, 2018
(86) PCT No.: PCT/EP2018/076766

§ 371 Date: Apr. 3, 2020

(30) Foreign Application Priority Data
Oct. 5, 2017 (DK) PA201770755

(51) Int. Cl. E06B 9/36

(52) U.S. Cl. CPC E06B 9/364; E06B 9/367

(57) ABSTRACT

The present invention relates to a lamella blind system comprising at least one lamella element having: a screen body made of a membrane material; a first rotatable mount with a first clamp engaging a first end of the screen body; and a second rotatable mount with a second clamp engaging a second end of the screen body; wherein the screen body is clamped between the first and second rotatable mounts; wherein the screen body is loaded with a pre-determined tension applied in an axial direction parallel to the axis of rotation; and wherein the lamella element is rotatable about an axis of rotation defined by the first and second rotatable mounts; a first support structure supporting the first rotatable mount; a second support structure supporting the second rotatable mount; and a drive mechanism for controlling the rotational position of the at least one lamella element, wherein the drive mechanism is a single-ended drive mechanism acting on only one of the first and second rotatable mounts of the at least one lamella element.

The present invention relates to a lamella blind system comprising at least one rotatable lamella element. According to a particular aspect, the invention relates to a vertical lamella blind system.

### BACKGROUND OF THE INVENTION

Adjustable lamella blind systems are employed for controlling the energy balance as well as the light conditions inside buildings with a facade exposed to incoming sunlight. Such adjustable lamella blind systems exist in numberless variations as to the technical details of their design and operation, both for interior and exterior use. Exterior mounted blind systems usually have the advantage of more effectively controlling the solar induced heating of a building exposed to incoming sunlight. However, particular challenges arise when such sun-screens are to be scaled up for covering large window sections and/or mounted outside the climate-controlled/protected shell of large buildings. Such issues include the excessive weight, system complexity, and cost of known blind systems, in particular if they are of the adjustable type. Furthermore, many known blind systems for exterior mounting are rather sturdy and thus tend to dominate the architectural expression of a building, or at least severely limit the freedom of architectural design.

Therefore, there is a need for a lamella blind system addressing the issues of known lamella blind systems. Object of the present invention is therefore to provide an improved lamella blind system that overcomes at least some of the issues of known lamella blind systems.

### SUMMARY OF THE INVENTION

According to one aspect, the object of the invention is achieved by a lamella blind system as defined by independent claim 1, wherein advantageous embodiments are defined by the dependent and further embodiments as disclosed in the following.

In one aspect, the invention relates to a lamella blind system comprising at least one lamella element having a screen body made of a membrane material; an first rotatable mount with an first clamp engaging an first end of the screen body; and a second rotatable mount with a second clamp engaging a second end of the screen body; wherein the screen body is clamped between the first and second rotatable mounts; wherein the screen body is loaded with a pre-determined tension applied in an axial direction parallel to the axis of rotation; and wherein the lamella element is rotatable about an axis of rotation defined by the first and second rotatable mounts; the lamella blind system further comprising an first support structure supporting the first rotatable mount; a second support structure supporting the second rotatable mount; and a drive mechanism for controlling the rotational position of the at least one lamella element, wherein the drive mechanism is a single-ended drive mechanism acting on only one of the first and second rotatable mounts of the at least one lamella element.

The lamella blind system is useful for controlling the energy balance inside buildings with a facade exposed to incoming sunlight. The lamella blind system is further useful for adjusting and controlling the amount of incoming light transmitted from the outside to the inside of a building. According to some embodiments, the lamella blind system is for exterior screening of incoming sunlight. Further according to some embodiments, the exterior screening is arranged in a so-called double facade, where the lamella blind system is located between an outer glazing layer, facing towards the outside of the building, and an inner glazing layer, facing towards the inside of the building.

The screen body is made of a membrane material, in particular a light-weight membrane material, thereby considerably reducing the requirements for the structural strength of the supporting structure as compared to traditional exterior blinds of the adjustable type. Thereby, a simplified building construction and a less dominant expression of the technical construction associated with the blind system is achieved, thus reducing building cost and providing more freedom for the architectural design of the facade.

The rotatable mounts each comprise a clamping portion for engaging/clamping the screen body, and a bracket portion adapted for attaching the mount to a respective supporting structure of the lamella blind system, such as a rail, beam, strut, or brace of a facade construction, a projecting roof, a projecting floor slab, and/or a similar building element. The clamping portions of the rotatable mounts are rotatable with respect to the corresponding bracket portions about an axis of rotation.

The axis of rotation defines the axial direction of the lamella element, i.e. the term “axial” as used herein refers to directions parallel to the axis of rotation of the lamella element. In some contexts the term “transverse” is used in relation to axial directions. Transverse directions are oriented essentially perpendicular to the axial directions.

Under operational conditions, the axis of rotation of a lamella element in a vertical lamella blind system is oriented in a vertical direction, whereas the axis of rotation of a lamella element in a horizontal lamella blind system is oriented in a horizontal direction. The terms “vertical” and “horizontal” are defined in relation to the direction of gravity, where vertical directions are parallel to the direction of gravity, and horizontal directions are perpendicular to the direction of gravity. The terms “upper” and “lower” refer to vertical locations of the thus designated elements or positions, i.e. an upper element would under normal operation be located above a corresponding lower element, as seen in a vertical direction.

At least one of the rotatable mounts is connected to a drive mechanism for controlling the rotational position of the rotatable portion of the lamella element with respect to the fixed first and second brackets. The drive mechanism is a single-ended drive configured for driving the rotation of the clamping portion with respect to the bracket portion of one of the mounts, which may be referred to as the “driven mount”, whereas the other mount may be referred to as a “following mount” adapted to follow that rotation due to torsional forces transmitted from the driven mount through the screen body to the following mount.

Advantageously, the drive mechanism is connectable/connected to a motor allowing for remote and/or automated positioning of the at least one lamella element. The motor is typically arranged to drive multiple lamella elements. However, it may also be conceived to provide multiple motors, each driving a lamella element or a group of multiple lamella elements. Typically, a lamella blind system has a plurality of lamella elements, which are operated in a coordinated manner, usually simultaneously. Typically, the lamella elements are driven in a synchronized manner allowing for a synchronous, or at least correlated, rotational positioning of the lamella elements of the blind system. Advantageously, the motorized operation of the lamella elements of a lamella blind system is controlled by a control unit according to programmed instructions, user input, and/or sensor inputs.

By providing a single-ended drive mechanism that only acts from one end of the at least one lamella element, via one of the two rotatable mounts thereof, the mechanical complexity of the lamella blind system is considerably simplified. Furthermore, the weight of the system may be reduced. As described above the single-ended drive mechanism driving one of the mounts implies that the other mount follows, wherein at least a major part and preferably all of the torque forcing the rotational motion about the axis of rotation is transmitted through the screen body connecting the first mount to the second mounts. The single-ended drive mechanism therefore requires an adequate torsional stiffness of the screen body in order to avoid unacceptable deformation and ensure shape integrity of the lamella during operation. This is a particular challenge when using a flexible material, such as a membrane material, in particular a light weight membrane material, as material for the screen body that does not have the inherent torsional stiffness of a blade made of e.g. a metallic material. Examples of useful membrane materials include a thin foil, a thin polymer film, a woven textile material, a non-woven textile material, a fibre based material, or similar thin, light-weight, flexible, soft, and/or pliable sheet materials. When using such light-weight flexible materials as a membrane material for the screen body, the torsional stiffness required for a single ended drive mechanism is in fact a limiting factor, if not a prohibitive factor. By applying an axial tension to the screen body, the torsional stiffness is increased, thereby facilitating the combined use of a single-ended drive mechanism with light-weight flexible materials, such as those mentioned above.

Adding a predetermined tensional load to the membrane material, wherein the tension is applied in the axial direction of the screen body, thus enhances the torsional stiffness and shape stability of the screen body. In this way, a screen body may be configured for transmitting the required torque from the driven mount to the following mount by enhancing the torsional stiffness and shape stability accordingly. This is achieved by loading the membrane material of the screen body with the additional axial tension according to a given required increase in torsional stiffness. The tension is applied to the screen body through the rotatable mounts pulling on the opposite ends of the screen body in opposite axial directions apart from each other. An upper limit to the tension that can be applied to a screen body made of a given membrane material is determined by the tensional properties of that given membrane material, such as an upper limit for avoiding undesired stretching of the membrane material, elastic deformation, or even rupture. The actual torsional stiffness required for a given system may be determined by the skilled person taking into account standard mechanical design parameters for a given blind system, such as the speed/acceleration for the rotational positioning of the lamella elements, angular mass distribution of the lamella elements, and dissipative mechanisms like friction in the bearings of the following mount.

By transmitting the torque for rotating the lamella element through the membrane material of the screen body, no through-going drive shaft or axle extending from the first rotatable mount to the second rotatable mount is required. Enhancing the torsional stiffness and shape stability of the screen body itself also reduces or even eliminates the need for providing any additional stiffening elements connecting the first and second mounts of the lamella elements of the blind system. It is desirable to avoid any such additional stiffening or tensioning elements, drive shafts, axles or similar elements extending from the first to the second mounts of the lamella elements, as any such additional elements may obstruct or perturb the view out of the building and may cause undesired shadow effects inside the building.

Most preferably, the first and second rotatable mounts of the lamella elements are only connected through the membrane material of the screen body. Accordingly the first support structure of the lamella blind system is only connected to the second support structure through the screen body of the lamella elements—at least within a window area covered by the lamella blind system. Thereby it is achieved that any of the above-mentioned undesired visual obstructions or shadow effects can be eliminated, or at least brought to a minimum, thus leaving the visual appearance and optical effects of the blind system as a matter of architectural design. Eliminating visual obstructions or undesired shadow effects is particularly relevant for screen bodies that are made of a transparent, translucent, or semi-transparent membrane material, i.e. materials that are adapted to reduce the intensity of the incoming radiation, modify the spectral distribution of the incoming radiation, diffract or diffuse the incoming radiation, and/or otherwise transform the incoming radiation, but which are not adapted to fully block incoming light at least in the visible portion of the electromagnetic spectrum. However, avoiding a through-going drive shaft, axle or similar additional elements is also advantageous for blind systems with fully opaque lamella elements, e.g. in order to avoid perturbing the view in an open state of the blind system by any such elements, and to reduce system complexity and weight.

Advantageously according to some embodiments, the lamella blind system is a vertical lamella blind system, wherein the lamella elements are arranged for rotation around a vertical axis. A vertical lamella blind system may thus comprise: at least one lamella element having a screen body made of a membrane material; an upper rotatable mount with an upper clamp engaging an upper end of the screen body; and a lower rotatable mount with a lower clamp engaging a lower end of the screen body; wherein the screen body is clamped between the upper rotatable mount and the lower rotatable mount; wherein the screen body is loaded with a pre-determined tension applied in an axial direction parallel to the axis of rotation; and wherein the lamella element is rotatable about a vertical axis of rotation defined by the upper and lower rotatable mounts; an upper support structure supporting the upper rotatable mount; a lower support structure supporting the lower rotatable mount; and a drive mechanism for controlling the rotational position of the at least one lamella element, wherein the drive mechanism is a single-ended drive mechanism acting on only one of the upper and lower rotatable mounts of the at least one lamella element. A vertical orientation of the axis of rotation of the lamella elements has e.g. the advantage that the axial tension is applied along the direction of gravity, thereby reducing off-axis forces on the rotatable mounts.

Advantageously according to some embodiments, the lamella blind system may also be a horizontal lamella blind system, wherein the lamella elements are arranged for rotation around a horizontal axis. By applying a pre-determined tension in the axial direction, the use of a membrane material for the screen body is facilitated. In particular, the use of a thin, light-weight, flexible, soft, and/or pliable sheet material that does not have the inherent shape stability of the stiff lamella materials commonly used for horizontal lamella blinds is thereby facilitated. Furthermore, prominent vertical lines, e.g. resulting from suspending and actuation strings, as usually seen in horizontal lamella blind systems can thereby be avoided. In particular, by the single-ended drive of the tensioned horizontally oriented lamella elements a simple, lightweight and cost-effective system is provided that has a discreet visual appearance, and thus leaves more flexibility to the architectural design.

Further according to some embodiments, the lamella blind system further comprises at least one elastic element, such as a helical spring, providing an axially oriented bias determining the tension applied to the screen body. Preferably, each lamella element of the blind system is provided with the at least one elastic element. Further preferably, an elastic element is integrated in the first rotatable mount and/or in the second rotatable mount. Thereby a well-defined tension may be applied to the screen body clamped between the first and second mounts, wherein the axial tension is pre-determined by the elastic properties of the chosen at least one elastic element. According to some embodiments, the elastic element comprises a helical spring. According to some embodiments, the principal axis of the helical spring is axially oriented and arranged in the first or the second rotational mount concentric with the axis of rotation. Further according to some embodiments, the elastic element is arranged in the following mount, opposite to the driven mount of the at least one lamella element. Thereby, a simple and reliable construction is achieved.

Further according to some embodiments, the lamella blind system further comprises an adjustment mechanism for adjusting the axial bias provided by the elastic element. Thereby, a fine-tuning to the correct tension to be applied to the screen body of the at least one lamella element can be performed. According to some embodiments each of the lamella elements are provided with such an elastic element with adjustable bias. Thereby, each of the lamella elements can individually be fine-tuned to the correct tension. Adjustment of the tension bias may be performed at the site of installation of the lamella blind system, e.g. upon installation or after some time for service or maintenance. A spring loaded support including an elastic element may further compensate for any thermal expansion/contraction effects, so as to maintain the tension applied to the screen body at a predetermined value, or at least within a pre-determined range.

Further according to some embodiments of the lamella blind system, the screen body is made of a fibre-based material, such as a woven textile or a non-woven textile.

As mentioned above, the single ended drive mechanism requires an adequate torsional stiffness and shape stability of the screen body in order to properly transfer the torque from the driven mount to the following mount without significant torsional deformation of the screen body. This is a particular challenge when using a flexible web as the membrane material for the screen body, such as a thin foil, a thin polymer film, a woven textile material, a non-woven textile material, a fibre based material, or any similar thin, light-weight, soft, and/or pliable sheet materials that do not have the inherent torsional stiffness of a blade made of e.g. a metallic sheet material. However, as also mentioned above, a limiting factor may be the tensional properties of the flexible web material. This limit may be pushed, by using a fibre based material as the membrane material for the screen body providing a high tensional strength with a low tendency to stretching deformation. This allows for applying increased tensional loads in the axial direction thereby further enhancing the torsional stiffness and shape stability of the lamella elements.

Further according to some embodiments of the lamella blind system the first clamp of the at least one lamella element and/or the second clamp of the at least one lamella element are curved as seen in a direction perpendicular to the axial direction so as to impose a curved profile on the screen body with a convex front side and a concave back side. A convex/concave profile of the screen body as seen in a cut plane perpendicular to the axial direction is thus obtained. The convexly bulging side of the screen body is the front side. The reverse, concavely bulging side of the screen body is the back side. Thereby, improved apparent shape fidelity of the screen body under the influence of torsional forces is achieved. This allows for preserving the general visual expression of the lamella blind system also under operational conditions. Furthermore, the curved profile may achieve a “softer” appearance, incoming light is reflected in different directions, and torsional deformations or small stretch marks become less apparent, thus further contributing to preserving the general visual expression of the lamella blind system under operational conditions. Imposing the curved profile in combination with applying an axial tensioning to the screen body is thus particularly advantageous for achieving the desired torsional stiffness and shape stability of the screen body for providing a consistent and aesthetically acceptable appearance of the lamella blind system also under operational conditions. In particular, the combination allows for achieving an adequate torsional stiffness and torsional shape stability even when a very flexible light weight membrane material is used for the screen body.

Further according to some embodiments of the lamella blind system, the axis of rotation of the at least one lamella element is off-set with respect to the screen body in a direction perpendicular to the axial direction. By thus moving the axis of rotation out of the plane of the screen body, the general torsional stability of the lamella element is improved, since the screen body is not only twisted, but also displaced, when the lamella element is rotated.

Advantageously according to some embodiments of the lamella blind system, the axis of rotation is offset so as to pass through the geometric centre of the profile of the screen body as seen in a cut-plane perpendicular to the axial direction. Thereby, it is achieved that the distributed tensioning forces act symmetrically on the rotational mounts, such that off-axis forces on the rotatable mounts are reduced or even cancelled.

Advantageously according to some embodiments of a vertical lamella blind system, the axis of rotation is offset so as to pass through the centre of gravity of the screen body with a curved profile. Thereby, it is achieved that off-axis forces on the rotational mounts resulting from gravitation acting on the lamella element are eliminated. For the curved profile embodiments this means that the axis of rotation typically is located outside the material of the screen body and oriented in an axial direction parallel to the screen body.

Further advantageously according to some embodiments of a vertical lamella blind system, the screen body profile is shaped such that the centre of gravity and the geometric centre coincide. By placing the axis of rotation in a balanced position according to these embodiments, with reduced off-axis forces acting on the rotational mounts, an improved operation of the rotational mounts is achieved, amongst others contributing to the reduction of friction in the bearings and enhancing the reliability/longevity of these bearings. Furthermore this allows for reducing the torque required for operating the at least one lamella element, thereby further reducing system complexity, weight and cost.

Further according to some embodiments of the lamella blind system, the first clamp of the at least one lamella element engages the first end of the screen body with a first clamping force having a first axial tensioning force component that is uniformly distributed in a transverse direction across the first end of the screen body, and/or wherein the second clamp of the at least one lamella element engages the second end of the screen body with a second clamping force having a second axial tensioning force component that is uniformly distributed in a transverse direction across the second end of the screen body. Thereby, the risk of creating visually unappealing stretch marks in the flexible membrane material of the screen body is mitigated.

Preferably, both the first and second clamps engage the respective first and second ends of the screen body with an axial tensioning force that is uniformly distributed along the engaged ends, as seen in a transverse direction of the screen body. Thereby, the occurrence of visually unappealing stretch marks in the flexible membrane material of the screen body is avoided best.

Typically, the clamping force itself is already uniformly distributed in a transverse direction along the edge of the screen body engaged by the clamp, wherein the terms “clamping” and “clamping force” refer to any means for engaging the edge of the screen body with the respective first and second clamps, such as by glue bonding, thermal bonding, ultrasonic welding, friction-fit engagement, form-fit engagement, or the like.

Further according to some embodiments of the lamella blind system, the screen body of the at least one lamella element comprises a transversely oriented beading along at least one of the second and first ends; wherein the corresponding one of the second and first clamps comprises a recess cavity receiving the beading therein and a contact surface contacting a portion of the screen body adjacent to the beading (and proximal thereof) so as to define a shape of a profile of the screen body as seen in a cut-plane perpendicular to the axial direction, the recess cavity and the corresponding contact surface extending in a transverse direction across the full width of the screen body. Thereby a clamping mechanism is obtained that is easy to assemble in production and ensures a uniform distribution of the axial tensioning forces transferred from the clamp to the membrane material of the screen body.

Advantageously according to some embodiments, the contact surface is also an attachment surface where the screen body is attached to the contact surface. Preferably, the contact surface is a shape defining surface for defining the shape of the screen body profile at the engaged ends. Thereby a further enhanced uniformity of the tension force distribution is achieved.

Advantageously, the recess cavity is formed between a front part and a backing part, in combination forming the respective clamp, and the shape defining contact surface is provided by at least one of the front and backing parts of the clamp, e.g. comprising an inwardly facing surface in a slit leading to the recess cavity, at the interface between the front and backing parts. Alternatively or in addition thereto, the shape defining contact surface may also comprise an outwardly facing surface of one of the front and backing parts. Thereby a further improved clamping mechanism is obtained that is easy to assemble in production and ensures a uniform distribution of the axial tensioning forces transferred from the clamp to the membrane material of the screen body. In a synergistic combination with the requirement of a curved shape of the clamps of the first and/or second rotatable mounts, a distributed clamping can be achieved for a given tension specification with a particularly slender construction, thereby achieving a more discreet appearance.

Further according to some embodiments of the lamella blind system, the second rotational mount comprises a detachable coupling adapted for tool-free operation. Such a detachable coupling for tool-free operation is preferably configured for rapid connection/disconnection, typically by hand, and is particularly useful for frequent cleaning, service, and/or maintenance operations on and/or around the lamella blind system, such as window cleaning. The actual tension applied to the screen body is determined by the axial tensioning applied between the first and second mounts. The coupling, therefore, has to be adapted to transmit at least that axial tension. In a connected state, said coupling is configured with a minimum axial coupling strength, i.e. a coupling strength that would allow for transmitting an axial force there through, that exceeds the axial tension to be applied to the screen body. The axial tension applied through the lamella elements enhances the overall stability and precision in response of the lamella blind system by reducing the detrimental effect of clearances throughout the construction. The axial tension thus facilitates the use of a relatively simple detachable coupling, without jeopardizing the stability of the system.

According to particularly advantageous embodiments, the tool-free coupling is combined with a tensioning device comprising an elastic element that allows for setting the tension bias as described above. Thereby, a pre-set axial tension is easily reestablished without the need for tedious readjustment after disconnection and reconnection of a lamella element.

Advantageously, the tensioning device is arranged in or at the first rotatable mount. Further according to some embodiments, the drive mechanism is placed at the second end and is arranged to drive the rotation of the at least one lamella element from the second end. Further according to some embodiments, the detachable coupling for tool-free operation is arranged in or at the second rotatable mount, such as concentrically engaging a drive axle of the drive mechanism, said drive axle being arranged in the axis of rotation of the at least one lamella element. Examples for useful detachable tool-free couplings are a snap-fit engagement, a combination of spring-loaded, thumb-screw-driven, and/or lever-operated protruding elements gripping into a cooperating indentation, slot, notch, groove, rim, or the like.

### BRIEF DESCRIPTION OF THE DRAWINGS

Preferred embodiments of the invention will be described in more detail in connection with the appended drawings, which show in

FIG. 1 a side elevational view of a lamella blind system according to one embodiment;

FIG. 2 a perspective view of the lamella blind system according to the embodiment of FIG. 1;

FIG. 3 a detail of a first rotational mount of a lamella element of the lamella blind system of FIG. 1; and in

FIG. 4 a detail of a second rotational mount of a lamella element of the lamella blind system of FIG. 1.

### DETAILED DESCRIPTION

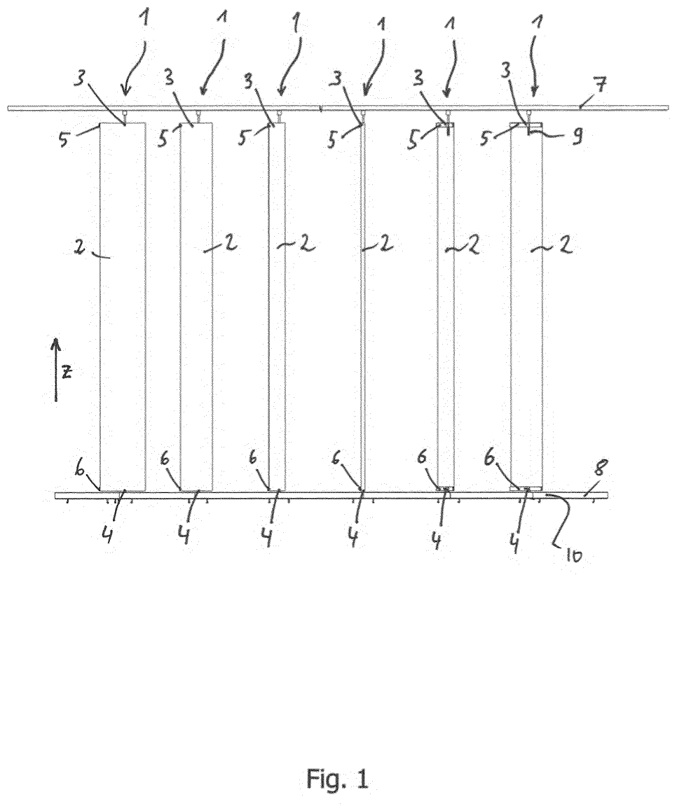

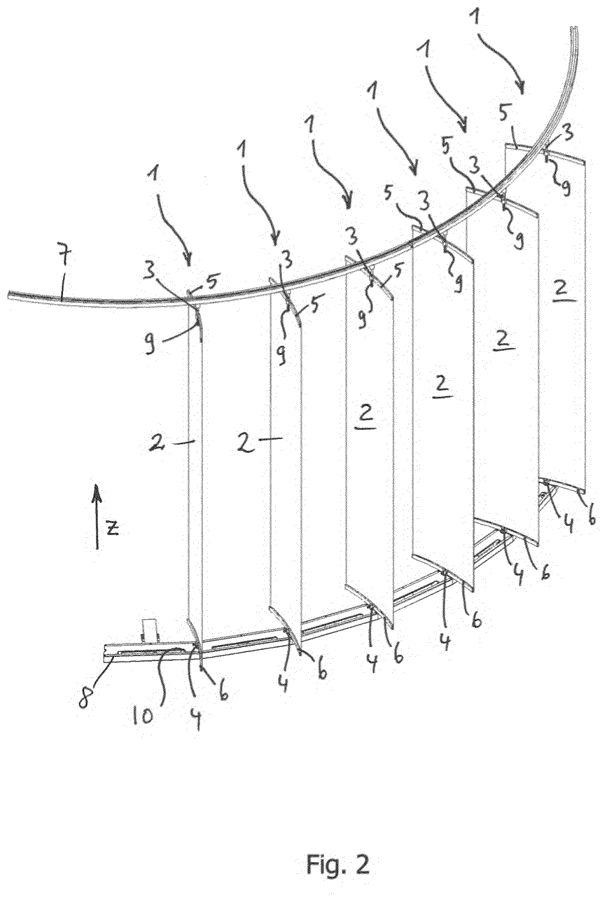

Referring to FIG. 1 and FIG. 2, a lamella blind system according to one embodiment has a plurality of lamella elements 1, each having a screen body 2 made of a textile material which is stretched out between a first rotational mount 3 and a second rotational mount 4. The first rotational mount has a clamp 5 engaging a first end of the screen body 2 and is held by a first support structure 7 shaped as a rail. The second rotational mount has a clamp 6 engaging a second end of the screen body 2 and is supported by a second support structure 8. The screen body 2 of each lamella element 1 is stretched out between the corresponding first and second mounts 3, 4, wherein each pair of first and second rotatable mounts 3, 4 defines a respective axis of rotation R oriented in an axial direction. The axial direction is indicated in the drawings by arrow z. In each of the lamella elements 1, a tension bias pulling the first and second ends of the screen body 2 in opposite directions apart from each other is applied in the axial direction z. The applied tension bias is in excess to any forces required for merely holding the membrane material of the screen body 2 stretched out and in shape. The applied axial tension increases the torsional stiffness of the screen body 2, thereby allowing for driving the lamella element 1 from a single end. A tensioning element 9 arranged in the first rotatable mount 5 of each of the lamella elements 1 ensures that the applied tension is within a well-defined (predetermined) range of axial tension values. In the embodiment shown here, the second rotatable mount 4 is driven by a drive mechanism 10 integrated in the second support structure 8 of the lamella blind system. The clamps 5, 6 of the first and second rotational mounts 3, 4 are curved and thereby define a curved profile of the screen body 2 clamped there between, wherein a front side of the screen body 2 is convex and a back side of the screen body 2 is concave.

The lamella blind system may be fixed to a building structure by means of the first and second support structures 7, 8. Preferably, the lamella blind system is attached at the outside of building, and/or may be integrated in a double facade, e.g. between the inner glazing and the outer glazing of such a double facade. The drive mechanism 10 preferably comprises a motor for actuating the lamella elements 2 in an automated manner. The motor may be any suitable positioning motor, such as an electric motor. Multiple lamella elements 1 may be grouped to be actuated simultaneously. The lamella blind system may further comprise a control unit (not shown) comprising programmed instructions for operating the lamella elements in a programmed manner, e.g. in response to a time schedule and/or sensor input, such as light sensitive sensors, and/or temperature sensors. The sensors may be arranged in the interior of the building and/or at the exterior of the building depending on the desired control scheme. The programmed instructions may also be programmed to position the lamella elements 1 according to a predetermined pattern. For example, the curved profile lamella may be controlled to be oriented in accordance with the curvature of the supporting structure and/or a curvature in the facade along a horizontal direction: e.g. such that at a convex portion of the facade, as seen from the outside of the building, the convex front side of the lamella also face in an outward direction away from the building; and/or such that at a concave portion of the façade, as seen from the outside of the building, the concave backside of the lamella also faces in an outward direction away from the building. Furthermore the lamella blind system may also be operable in response to user input.

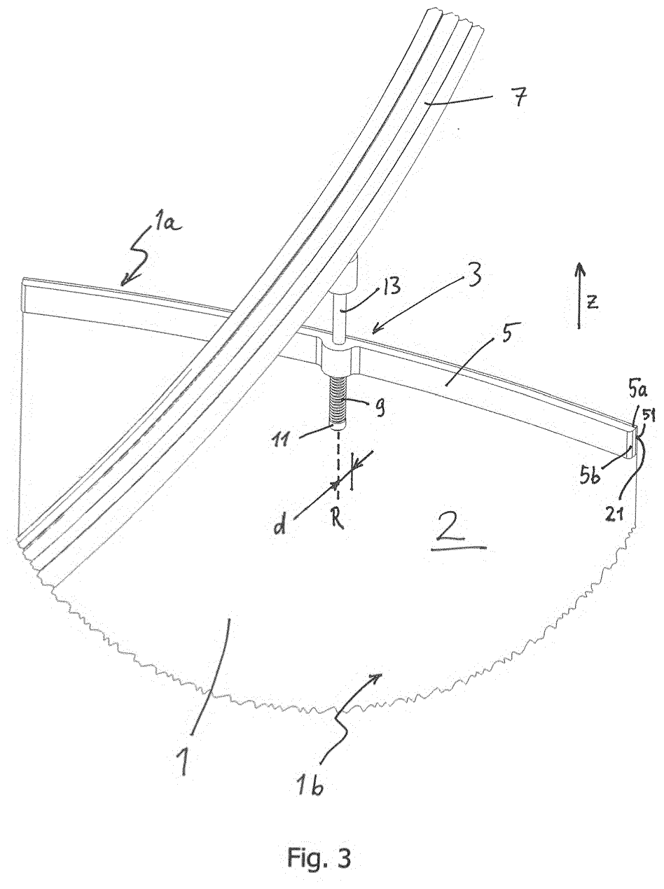

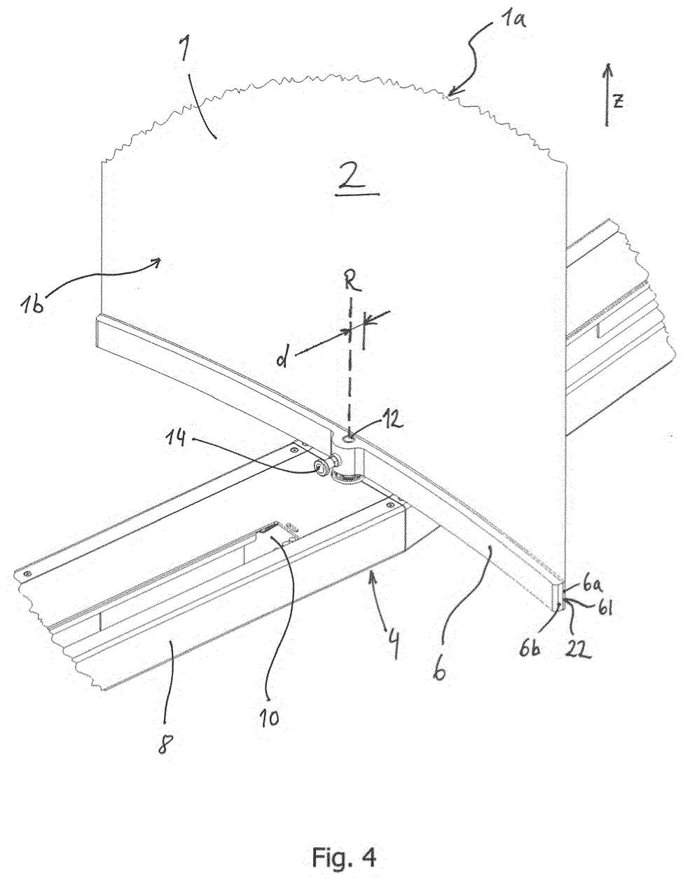

Referring now to FIG. 3 and FIG. 4, details of the first and second rotatable mounts 3, 4 are now discussed, respectively.

FIG. 3 shows a detail of the first rotational mount 3 of a lamella element 1 of the lamella blind system of FIG. 1 and FIG. 2. The first rotatable mount 3 has a curved clamp 5 clamping the first end of the screen body 2 so as to define a curved profile of the lamella element 1. The first rotatable mount 3 further comprises a stud axle 13 suspending the curved clamp 5 for rotation about an axis of rotation R (broken line), which is offset in a transverse direction perpendicular to the screen body 2 by a distance d so as to pass through the geometric centre of the curved lamella element 1 so as to balance off-axis components of the tension forces acting on the rotatable mounts. A front side 1a of the lamella element 1 facing away from the axis of rotation R is convexly shaped, whereas a back side 1b of the lamella element 1 facing towards the axis of rotation R is concavely shaped. The first clamp 5 has a front part 5a and a backing part 5b. A hollow channel 51 is formed as a recess cavity at the interface between the front part 5a and the backing part 5b. The recess cavity follows the interface in a transverse direction and extends from end to end of the curved clamp 5. The recess cavity is shaped and dimensioned to receive therein a beading 21 formed along a transverse edge at the first end of the screen body 2. The screen body is thereby engaged in a uniformly distributed manner between the front part 5a and the backing part 5b. The screen body 2 is then lead in distal direction parallel to the direction z (arrow), bent and wrapped around the distal end of the front part 5a to contact a shape defining front surface of the front part 5a, and guided further in a proximal direction towards the second rotatable mount 4. Thereby a uniformly distributed tensioning force may be applied to the first end of the screen body 2 in a simple and production friendly manner. Furthermore, this clamping construction allows for a discreet design of the lamella element. The stud axle 13 is supported by the first support structure 7 and extends in an axial direction through the clamp 5. The first rotatable mount 3 further comprises an elastic element 9, here shaped as a helical compression spring arranged concentrically around the axis of rotation R and resting against a seat portion 11 on the stud axle 13. The clamp 5 rests against an opposite end of the elastic tensioning element 9. The elastic element 9 maintains an axial tension applied to the screen body in a distal direction with respect to the screen body 2, against the clamping engagement of the second rotatable mount 4. The tensioning forces are taken up by the first and second support structures 7, 8, which in turn are fixed to a building structure (not shown). The axial position of seat 11 may be adjustable, e.g. by a threaded attachment, in order to adjust the tension bias exerted on the clamp 5 by the elastic element 9.

FIG. 4 shows a detail of the second rotational mount 4 of a lamella element 1 of the lamella blind system of FIGS. 1 and 2. The second rotatable mount 4 has a curved clamp 6 clamping the second end of the screen body 2 so as to define a curved profile of the lamella element 1. The second rotatable mount 4 further comprises a drive axle 12 engaging the curved clamp 6 for rotation about the axis of rotation R (broken line), which is offset in a transverse direction perpendicular to the screen body 2 by a distance d so as to pass through the centre of gravity of the curved lamella element 1. A front side 1a of the lamella element 1 facing away from the axis of rotation is convexly shaped, whereas a back side 1b of the lamella element 1 facing towards the axis of rotation is concavely shaped. Just like the first clamp 5, the second clamp 6 also has a front part 6a and a backing part 6b. A hollow channel is formed as a recess cavity 61 at the interface between the front part 6a and the backing part 6b. The recess cavity 61 follows the interface in a transverse direction and extends from end to end of the curved clamp 6. The recess cavity is shaped and dimensioned to receive therein a beading 22 formed along a transverse edge at the second end of the screen body 2. The screen body 2 is thereby engaged in a uniformly distributed manner between the front part 6a and the backing part 6b. The screen body 2 is then lead between the front part 6a and the backing part 6b in a distal direction antiparallel to the direction z, bent and wrapped around the distal end of the front part 6a to contact a shape defining front surface of the front part 6a, and guided further in a proximal direction towards the first rotatable mount 3. Thereby a uniformly distributed tensioning force may be applied to the second end of the screen body 2 in a simple and production friendly manner. Furthermore, this clamping construction at the second end allows for a discreet design of the lamella element 1, in particular in combination with the above-described clamping construction at the first end. The drive axle 12 is held by the second support structure 8 and extends in an axial direction into the clamp 6. The second rotatable mount 4 further comprises a rapid release mechanism 14, such as a spring loaded pin engaging a complementary recess on the drive axle 12. The release mechanism 14 is for manual activation using finger forces. Activating the rapid release mechanism 14, e.g. by pulling the pin out against its loading, allows for rapidly removing the clamp 6 from the drive axle 12. The rapid release mechanism 14 also defines an axial position of the clamp 6. When engaged, the mechanism 14 holds the clamp 6 in the axial position against the tension of the elastic element 9 of the first rotatable mount 3. As mentioned above, the tensioning forces are taken up by the first and second support structures 7, 8, which in turn are fixed to a building structure (not shown). The rapid release mechanism 14 thus provides a well-defined mounting position of the clamp 6 on the drive axle 12, which allows to rapidly placing the clamp 6 onto the drive axle 12 in the same position as prior to the release, and without the need for any re-adjustment of the axial tensioning bias. A drive mechanism 10 is provided in the second support structure 8, wherein the drive mechanism 10 is for engaging the drive axle 12 for rotating the lamella element 1 into a desired position as described herein before.

1. Lamella blind system comprising
at least one lamella element having: a screen body made of a membrane material; a first rotatable mount with a first clamp engaging a first end of the screen body; and a second rotatable mount with a second clamp engaging a second end of the screen body; wherein the screen body is clamped between the first and second rotatable mounts; wherein the screen body is loaded with a pre-determined tension applied in an axial direction parallel to the axis of rotation; and wherein the lamella element is rotatable about an axis of rotation defined by the first and second rotatable mounts;
a first support structure supporting the first rotatable mount;
a second support structure supporting the second rotatable mount; and
a drive mechanism for controlling the rotational position of the at least one lamella element, wherein the drive mechanism is a single-ended drive mechanism acting on only one of the first and second rotatable mounts of the at least one lamella element.
wherein the first clamp of the at least one lamella element engages the first end of the screen body with a first clamping force having a first axial tensioning force component that is uniformly distributed in a transverse direction across the first end of the screen body, and/or wherein the second clamp of the at least one lamella element engages the second end of the screen body with a second clamping force having a second axial tensioning force component that is uniformly distributed in a transverse direction across the second end of the screen body.

2. System according to claim 1, further comprising at least one elastic element, such as a helical spring, providing an axially oriented bias determining the tension applied to the screen body.

3. System according to claim 2, further comprising an adjustment mechanism for adjusting the axial bias provided by the elastic element.

4. System according to claim 1, wherein the screen body is made of a fibre-based material, such as a woven textile or a non-woven textile.

5. System according to claim 1, wherein the first clamp of the at least one lamella element and/or the second clamp of the at least one lamella element are curved as seen in a direction perpendicular to the axial direction so as to impose a curved profile on the screen body with a convex front side and a concave back side.

6. System according to claim 5, wherein the axis of rotation of the at least one lamella element is off-set with respect to the screen body in a direction perpendicular to the axial direction.

7. System according to claim 1, wherein the screen body of the at least one lamella element comprises a transversely oriented beading along at least one of the second and first ends; wherein the corresponding one of the second and first clamps comprises a recess cavity receiving the beading therein and a contact surface contacting a portion of the screen body adjacent to the beading so as to define a shape of a profile of the screen body as seen in a cut-plane perpendicular to the axial direction, the recess cavity and the corresponding contact surface extending in a transverse direction across the full width of the screen body.

8. System according to claim 1, wherein the second rotational mount comprises a detachable coupling adapted for tool-free operation, wherein said coupling in a connected state is adapted for transmitting an axial force there through exceeding the axial tension applied to the screen body.

9. System according to claim 1, wherein the axis of rotation of the at least one lamella element is oriented in a vertical direction.
